(19) United States
(12) Patent Application Publication
(10) Pub. No.: US 2005/0217327 A1
(43) Pub. Date: Oct. 6, 2005

(54) Key with removable head

(76) Inventors: Antonio Frias Frias, Malaga (ES); Tomas Cerdan Martin, Malaga (ES)

Correspondence Address: Horst M. Kasper, 13 Forest Drive, Warren, NJ, 07059, US

(21) Appl. No.: 10/519,377

(22) PCT Filed: Jun. 18, 2003
(86) PCT No.: PCT/ES03/00302

§ 371 Date: Jan. 31, 2005

(30) Foreign Application Priority Data
Jun. 21, 2002 (ES) U. 200201586

(51) Int. Cl. E05B 19/04

(52) U.S. Cl. 70/395; 70/408

(57) ABSTRACT

A key with a detachable head consisting of incorporating projections (11) on the end of the shaft (10), to which projections a head (1) is coupled by means of a slot (5), which head is formed by a body (2) provided in its central area with a perforation (4) provided with a stop (6) which retains the shaft (10) to the head (1), and vice versa.

### OBJECT OF THE INVENTION

The present specification refers to a key with a detachable head, whose purpose is based on being shaped like a key capacitated for being used conventionally after-attachment on a transversal body incorporated on a key ring which, with the collaboration of a plastic material part, permits its circular movement, this key in turn having the capacity of being used in a standard manner by means of the incorporation of the detachable head.

The head is capacitated so as to be incorporated oz removed by means of the coupling of a part acting as a retaining stop.

### BACKGROUND OF THE INVENTION

The applicant has knowledge of the current existence of a key shaft capacitated so as to be attached on special key rings to which they are coupled with the collaboration of a plastic material retaining part.

However, the applicant does not know of the current existence of an invention having the same features as those disclosed herein.

### DESCRIPTION OF THE INVENTION

The key with detachable head proposed by the invention is itself shaped as a novelty, permitting its use conventionally or with the collaboration of a key ring with suitable features.

More specifically, the key with detachable head object of the invention is constituted as from a shaft of a metallic material which, on the upper end, is provided with a semicircular machine finishing due to which the shaft can be inserted through a slot inside of a body constituting a head, being coupled to the central perimeter bearing a perforation coupled to a stop which prevents the outward movement of the layer, and at the same time capacitates the shaft to be moved due to actuation of the head.

On the coupling end, the shaft is provided with a smaller thickness than that of the total shaft body so that it can be suitably adapted inside of the head.

### DESCRIPTION OF THE DRAWINGS

In order to complement the description that is being made and for the purpose of helping to better understand the features of the invention, two sheets of drawings are attached to the present specification as an integral part thereof, which drawings, with an illustrative and non-limiting character, show the following:

FIG. 1 shows a frontal plan view of the upper and rear area, and at the same time a profile and duly sectioned view of the detachable head object of the invention, in collaboration with the shaft, forming the assembly.

FIG. 2 shows C-D views of the shaft-to-head coupling stop.

FIG. 3 shows a view of the shaft and head at the time of their attaching.

FIG. 4 lastly shows a perspective view of the object of the invention, the shaft and head being coupled together.

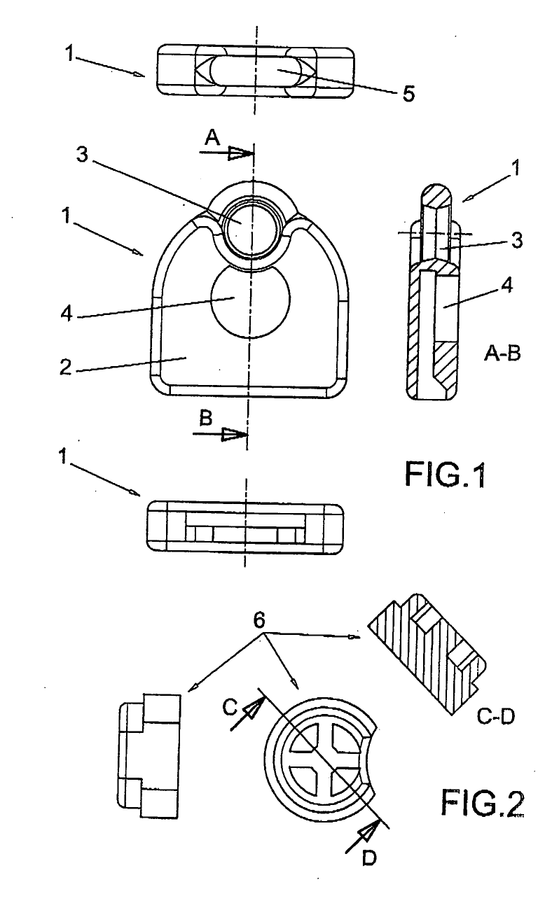

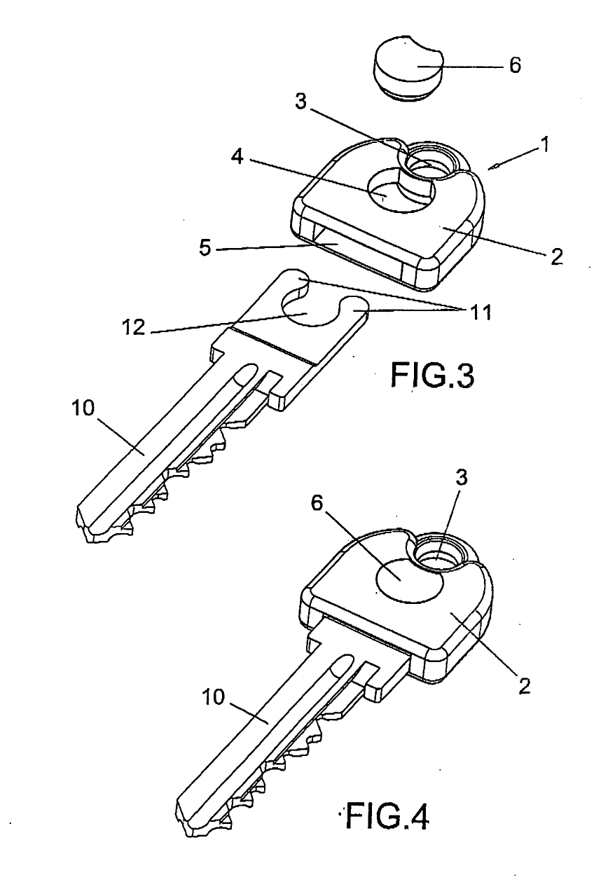

### PREFERRED EMBODIMENT OF THE INVENTION

In view of these figures, it can be seen how the key with detachable head is constituted as from a head (1) and a shaft (10), the head (1) being provided with a body (2) and a central perforation (4), an upper perforation (3) for its fixing to a conventional key ring, and a slot (5) for the introducing the upper end of the shaft (10) through it, which shaft is provided with two projections (11) forming a central semicircular area (12) which is coupled in the perimeter of perforation (4), being retained by the actuation of a stop (6) preventing the separation of parts (1) and (10).

In the case that the shaft (20) is to be coupled to a special key ring which permits its fixing with the collaboration of a plastic material part on its perimeter and moving in a semicircle, the shaft can be separated from the head (1) and be used for this purpose.

1. A key with detachable head, of those constituted as from a shaft (10) which, on the upper end, is provided with a machined finishing generated by two projections (11) which, in the central area, are provided with a semicircular area (12), this end of the shaft (10) having a thickness smaller than the rest of the shaft, characterized in that in the area formed by the projections (11), a head (1) is coupled through a slot, which head is provided with a body (2) which, in the central area, has a perforation (4) in which a stop (6) is introduced, retaining the shaft (10) together with the head.
